(19) United States
(12) Patent Application Publication
(10) Pub. No.: US 2024/0223533 A1
(43) Pub. Date: Jul. 4, 2024

(54) SYSTEM AND METHODS FOR FILTERING IN OBLIVIOUS DEPLOYMENTS AND DEVICES THEREOF

(71) Applicant: F5, Inc., Seattle, WA (US)

(72) Inventors: Ravi Sankar MANTHA, Bangalore (IN); Sagar BHURE, Hyderabad (IN)

(73) Assignee: F5, Inc., Seattle, WA (US)

(21) Appl. No.: 18/403,150

(22) Filed: Jan. 3, 2024

Related U.S. Application Data
(60) Provisional application No. 63/436,967, filed on Jan. 4, 2023.

(51) Int. Cl. H04L 9/40; H04L 61/4511

(52) U.S. Cl. CPC H04L 63/0236; H04L 61/4511; H04L 63/0281; H04L 63/166

(57) ABSTRACT

Methods, non-transitory computer readable media, network traffic manager apparatuses, and systems that assist with filtering content includes receiving a domain name system request from a client. Then, sending an address from the domain name system request to a policy server. The policy server can retrieve a filter id associated with the client. The method then includes sending the domain name system request with the filter id to an oblivious server. After, the method includes receiving a response with filtered content based on the domain name system request with the filter id from the oblivious server. The oblivious server can then generate a subscriber content filtering policy configuration based on the filter id and generate the response with the filtered content based on the subscriber content filtering policy configuration. Lastly, the methods includes sending the response to the domain name system request with filtered content to the client.

### CROSS-REFERENCE TO RELATED APPLICATIONS

This application claims priority to U.S. Provisional Application No. 63/436,967, filed on Jan. 4, 2023, which is hereby incorporated by reference in its entirety.

### FIELD

This technology relates to methods and systems for filtering in oblivious deployments while preserving client privacy.

### BACKGROUND

Oblivious domain name systems can offer privacy for clients when requests are sent to a network by preventing a single element in the network from knowing both the client identity as well as the requests that are being resolved. To prevent a single element in the network from knowing both the identity and the requests, an oblivious proxy can know the client's internet protocol address and an oblivious server can decrypt and handle the requests. However, due to the divided protocol between the client identity and requests in oblivious domain name systems, applying per-user policies to the request based on the client identity can be challenging.

For example, customized services like parental control and threat and malware prevention can be valuable to clients. However, such services are no longer possible when network elements cannot retrieve the customized services without the client identity.

As a result, a new method to enable network providers to apply per subscriber filtering policies without having to compromise client privacy in oblivious domain name systems is necessary.

### SUMMARY

A method implemented by a network traffic management system that includes receiving a domain name system request from a client and then sending an address from the domain name system request to a policy server. The policy server can retrieve a filter id associated with the client. The method then includes sending the domain name system request with the filter id to an oblivious server. After, the method includes receiving a response with filtered content based on the domain name system request with the filter id from the oblivious server. The oblivious server can then generate a subscriber content filtering policy configuration based on the filter id and generate the response with the filtered content based on the subscriber content filtering policy configuration. Lastly, the methods includes sending the response to the domain name system request with filtered content to the client.

A network traffic management device includes a memory including programmed instructions stored thereon and one or more processors configured to be capable of executing the stored programmed instructions to receive a domain name system request from a client. Then, the one or more processors can be further configured to send an address from the domain name system request to a policy server. The policy server can retrieve a filter id associated with the client. The one or more processors can then be further configured to send the domain name system request with the filter id to an oblivious server. After, the one or more processors can be further configured to receive a response with filtered content based on the domain name system request with the filter id from the oblivious server. The oblivious server can then generate a subscriber content filtering policy configuration based on the filter id and generate the response with the filtered content based on the subscriber content filtering policy configuration. Lastly, the one or more processors can be further configured to send the response to the domain name system request with filtered content to the client.

A non-transitory computer readable medium having stored thereon instructions for including executable code that, when executed by one or more processors, causes the processors to receive a domain name system request from a client. Then, the one or more processors can be further configured to send an address from the domain name system request to a policy server. The policy server can retrieve a filter id associated with the client. The one or more processors can then be further configured to send the domain name system request with the filter id to an oblivious server. After, the one or more processors can be further configured to receive a response with filtered content based on the domain name system request with the filter id from the oblivious server. The oblivious server can then generate a subscriber content filtering policy configuration based on the filter id and generate the response with the filtered content based on the subscriber content filtering policy configuration. Lastly, the one or more processors can be further configured to send the response to the domain name system request with filtered content to the client.

A network traffic management system with memory comprising programmed instructions stored thereon, and one or more processors configured to be capable of executing the stored programmed instructions to receive a domain name system request from a client. Then, the one or more processors can be further configured to send an address from the domain name system request to a policy server. The policy server can retrieve a filter id associated with the client. The one or more processors can then be further configured to send the domain name system request with the filter id to an oblivious server. After, the one or more processors can be further configured to receive a response with filtered content based on the domain name system request with the filter id from the oblivious server. The oblivious server can then generate a subscriber content filtering policy configuration based on the filter id and generate the response with the filtered content based on the subscriber content filtering policy configuration. Lastly, the one or more processors can be further configured to send the response to the domain name system request with filtered content to the client.

This technology provides a number of advantages including providing methods, non-transitory computer readable media, network traffic management devices, and network traffic management systems that can allow for the application of per subscriber DNS filtering policies without having to compromise on subscriber or client privacy in oblivious domain name systems.

### BRIEF DESCRIPTION OF THE DRAWINGS

FIG. 1 is a block diagram of an exemplary system architecture with a network traffic manager apparatus;

FIG. 2 is a block diagram of an exemplary system architecture with a DNS resolver;

FIG. 3 is a flow diagram of an exemplary method for filtering in oblivious deployments;

FIG. 4 is a flow diagram of an exemplary method for filtering subsequent requests in oblivious deployments;

FIG. 5 is an illustration of an exemplary system architecture with an oblivious proxy and target; and

FIG. 6 is sequence diagram of an exemplary method for filtering in oblivious deployments.

### DETAILED DESCRIPTION

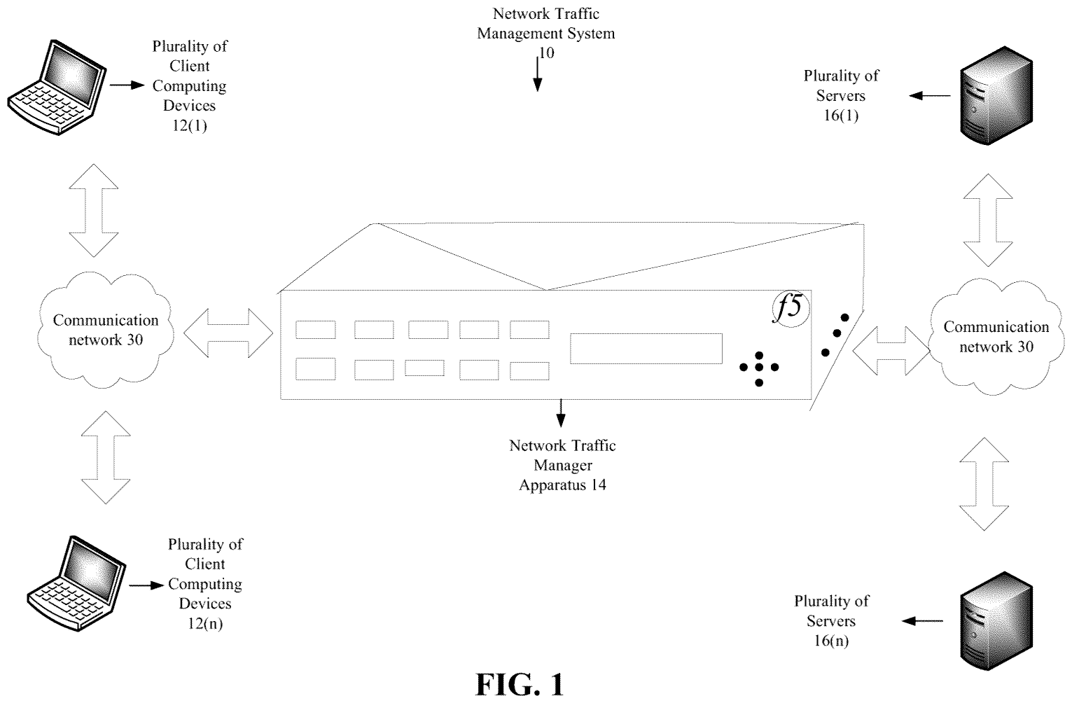

An example of a network environment 10 with a network traffic manager apparatus 20 for domain name system content filtering is illustrated in FIGS. 1-6. The exemplary environment 10 includes a plurality of client computing devices 12(1)-12(n), a network traffic manager apparatus 14, and a plurality of servers 16(1)-16(n) which are coupled together by communication networks 30, although the environment can include other types and numbers of systems, devices, components, and/or elements and in other topologies and deployments. While not shown, the exemplary environment 10 may include additional network components, such as routers, switches and other devices, which are well known to those of ordinary skill in the art and thus will not be described here. This technology provides a number of advantages including preventing network attack.

### DETAILED DESCRIPTION

An example of a network environment 10 with a network traffic manager apparatus 20 for domain name system content filtering is illustrated in FIGS. 1-6. The exemplary environment 10 includes a plurality of client computing devices 12(1)-12(n), a network traffic manager apparatus 14, and a plurality of servers 16(1)-16(n) which are coupled together by communication networks 30, although the environment can include other types and numbers of systems, devices, components, and/or elements and in other topologies and deployments. While not shown, the exemplary environment 10 may include additional network components, such as routers, switches and other devices, which are well known to those of ordinary skill in the art and thus will not be described here. This technology provides a number of advantages including preventing network attack.

Referring more specifically to FIG. 1, the network traffic manager apparatus 14 of the network traffic management system 10 is coupled to the plurality of client computing devices 12(1)-12(n) through the communication network 30, although the plurality of client computing devices 12(1)-12(n) and network traffic manager apparatus 14 may be coupled together via other topologies. Additionally, the network traffic manager apparatus 14 is coupled to the plurality of servers 16(1)-16(n) through the communication network 30, although the servers 16(1)-16(n) and the network traffic manager apparatus 14 may be coupled together via other topologies.

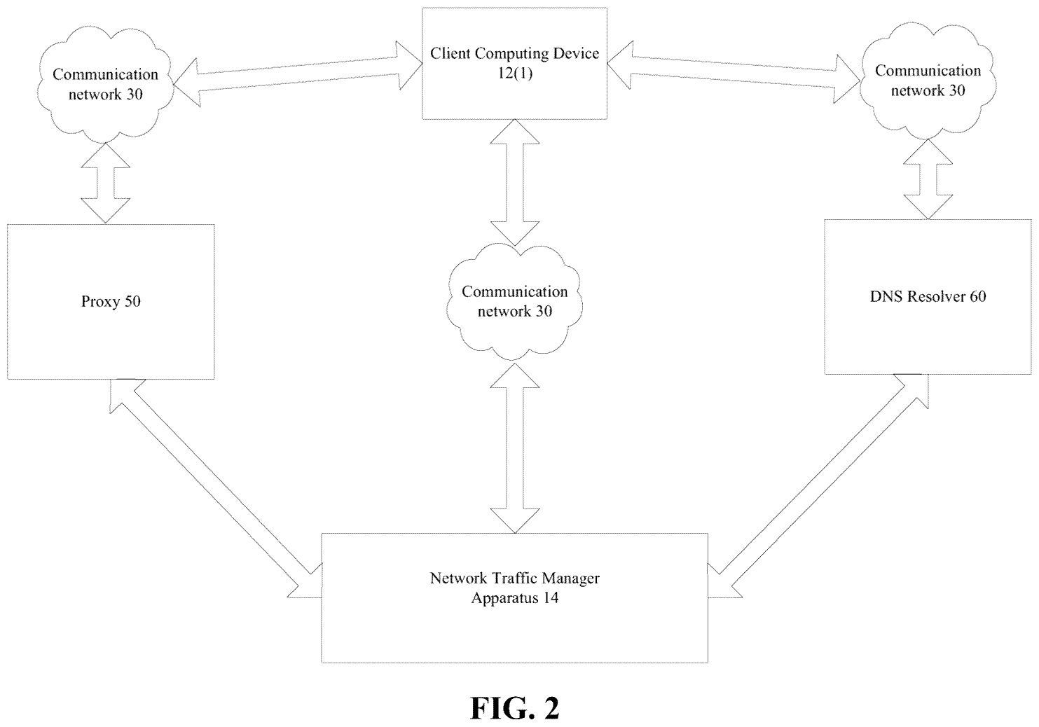

Referring specifically to FIG. 2, the network traffic manager apparatus 14 of the network traffic management system 10 is coupled to the plurality of client computing devices 12(1)-12(n), a Domain Name System (“DNS”) resolver or proxy server 60, and a proxy 50 through the communication network 30, although the network traffic manager apparatus 14 may be coupled to the plurality of client computing devices 12(1)-12(n), a Domain Name System (“DNS”) resolver 60, and a proxy 50 together via other topologies.

The network traffic manager apparatus 14 assists with filtering content as illustrated and described by way of the examples herein, although the network traffic manager apparatus 14 may perform other types and/or numbers of functions. The network traffic manager apparatus 14 includes processor or central processing unit (CPU), memory, and a communication system which are coupled together by a bus device although the network traffic manager apparatus 14 may comprise other types and numbers of elements in other configurations. In this example, the bus is a PCI Express bus in this example, although other bus types and links may be used.

The processors within the network traffic manager apparatus 14 may execute one or more computer-executable instructions stored in memory for the methods illustrated and described with reference to the examples herein, although the processor can execute other types and numbers of instructions and perform other types and numbers of operations. The processor may comprise one or more central processing units (“CPUs”) or general purpose processors with one or more processing cores, such as AMD® processor(s), although other types of processor(s) could be used (e.g., Intel®).

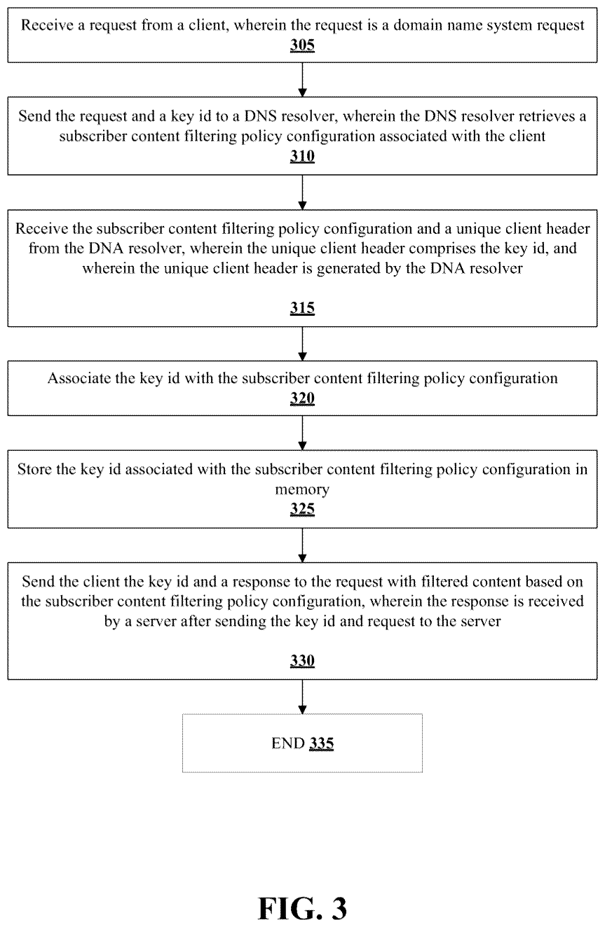

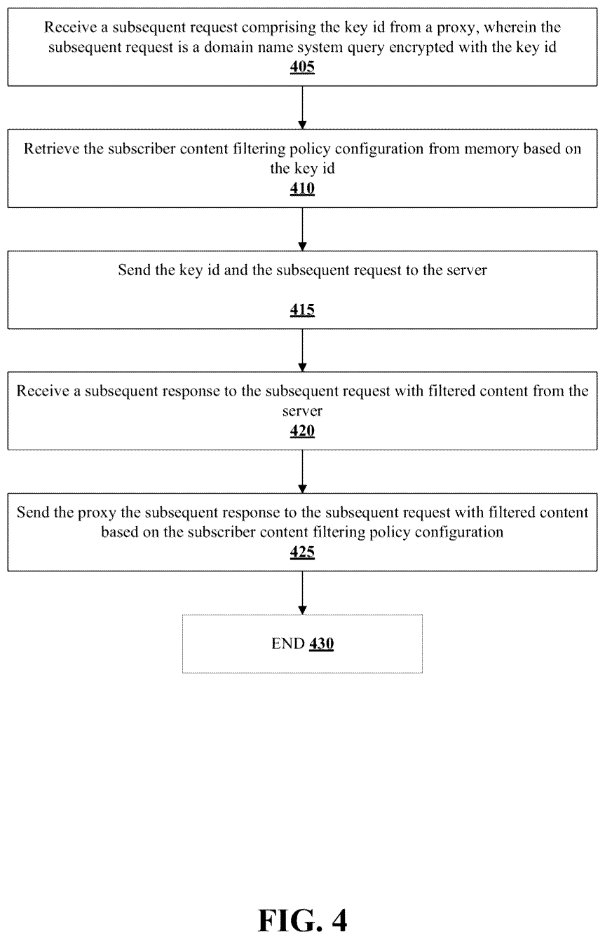

The memory within the network traffic manager apparatus 14 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. The memory may store one or more non-transitory computer-readable instructions of this technology as illustrated and described with reference to the examples herein that may be executed by the processor. The exemplary flowchart shown in FIGS. 3 and 4 is representative of example steps or actions of this technology that may be embodied or expressed as one or more non-transitory computer or machine readable instructions stored in the memory that may be executed by the processor and/or may be implemented by configured logic in the optional configurable logic 21.

Accordingly, the memory of the network traffic manager apparatus 14 can store one or more applications that can include computer executable instructions that, when executed by the network traffic manager apparatus 14, causes the network traffic manager apparatus 14 to perform actions, such as to transmit, receive, or otherwise process messages, for example, and to perform other actions described and illustrated below with reference to FIGS. 3-6. The application(s) can be implemented as module or components of another application. Further, the application(s) can be implemented as operating system extensions, module, plugins, or the like. The application(s) can be implemented as module or components of another application. Further, the application(s) can be implemented as operating system extensions, module, plugins, or the like. Even further, the application(s) may be operative in a cloud-based computing environment. The application(s) can be executed within virtual machine(s) or virtual server(s) that may be managed in a cloud-based computing environment. Also, the application(s), including the network traffic manager apparatus 14 itself, may be located in virtual server(s) running in a cloud-based computing environment rather than being tied to one or more specific physical network computing devices. Also, the application(s) may be running in one or more virtual machines (VMs) executing on the network traffic manager apparatus 14. Additionally, in at least one of the various embodiments, virtual machine(s) running on the network traffic manager apparatus 14 may be managed or supervised by a hypervisor.

The communication system 24 in the network traffic manager apparatus 14 is used to operatively couple and communicate between the network traffic manager apparatus 14, the plurality of client computing devices 12(1)-12(n), and the plurality of servers 16(1)-16(n) which are all coupled together by communication network 30 such as one or more local area networks (LAN) and/or the wide area network (WAN), although other types and numbers of communication networks or systems with other types and numbers of connections and configurations to other devices and elements may be used. By way of example only, the communication network such as local area networks (LAN) and the wide area network (WAN) can use TCP/IP over Ethernet and industry-standard protocols, including NFS, CIFS, SOAP, XML, LDAP, and SNMP, although other types and numbers of communication networks, can be used. In this example, the bus 26 is a PCI Express bus in this example, although other bus types and links may be used.

Each of the plurality of client computing devices 12(1)-12(n) of the network traffic management system 10, include a central processing unit (CPU) or processor, a memory, input/display device interface, configurable logic device and an input/output system or I/O system, which are coupled together by a bus or other link. The plurality of client computing devices 12(1)-12(n), in this example, may provide an interface to make requests for and send and/or receive data to and/or from the servers 16(1)-16(n) or the proxy 50 via the network traffic manager apparatus 14. Additionally, the plurality of client computing devices 12(1)-12(n) can include any type of computing device that can receive, render, and facilitate user interaction, such as client computers, network computer, mobile computers, mobile phones, virtual machines (including cloud-based computer), or the like. Each of the plurality of client computing devices 12(1)-12(n) utilizes the network traffic manager apparatus 14 to conduct one or more operations with the servers 16(1)-16(n), such as to obtain data and/or access the applications from one of the servers 16(1)-16(n), by way of example only, although other numbers and/or types of systems could be utilizing these resources and other types and numbers of functions utilizing other types of protocols could be performed.

Each of the plurality of servers 16(1)-16(n) of the network traffic management system include a central processing unit (CPU) or processor, a memory, and a communication system, which are coupled together by a bus or other link, although other numbers and/or types of network devices could be used. Generally, the plurality of servers 16(1)-16(n) process requests for providing access to one or more applications received from the plurality of client computing devices 12(1)-12(n), network traffic manager apparatus 14, via the communication network 30, but the principles discussed herein are not limited to this example and can include other protocols. A series of applications may run on the servers 16(1)-16(n) that allows the transmission of responses requested by the plurality of client computing devices 12(1)-12(n), or the network traffic manager apparatus 14. The plurality of servers 16(1)-16(n) may provide data or receive data in response to requests directed toward the respective applications on the plurality servers 16(1)-16(n) from the plurality of client computing devices 12(1)-12(n) or the network traffic manager apparatus 14. It is to be understood that the plurality of servers 16(1)-16(n) may be hardware or software or may represent a system with multiple external resource servers, which may include internal or external networks.

Although the plurality of servers 16(1)-16(n) are illustrated as single servers, each of the plurality of servers 16(1)-16(n) may be distributed across one or more distinct network computing devices. Moreover, the plurality of servers 16(1)-16(n) are not limited to a particular configuration. Thus, the plurality of servers 16(1)-16(n) may contain a plurality of network computing devices that operate using a master/slave approach, whereby one of the network computing devices of the plurality of servers 16(1)-16(n) operate to manage and/or otherwise coordinate operations of the other network computing devices. The plurality of servers 16(1)-16(n) may operate as a plurality of network computing devices within cluster architecture, a peer-to peer architecture, virtual machines, or within a cloud architecture. In some examples, the server 16(1) and oblivious server 16(2) can be a single server or network traffic manager apparatus 14.

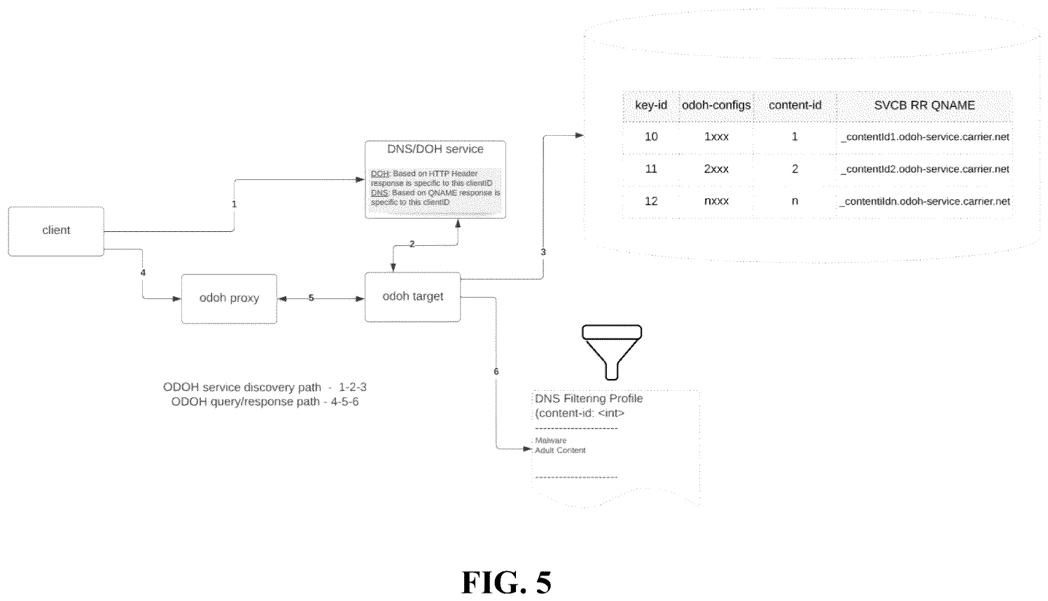

The proxy 50 can be one of the plurality of servers 16(1)-16(n) that proxies DNS queries and responses between the plurality of client computing devices 12(1)-12(n) and another one of the plurality of servers 16(1)-16(n). The proxy 50 can be a specialized server used to forward Oblivious DNS messages. Generally, the proxy 50 can include a central processing unit (CPU) or processor, a memory, and a communication system, which are coupled together by a bus or other link, although other numbers and/or types of network devices could be used. As illustrated in FIG. 5, the proxy 50 may provide data or receive data in response to requests directed toward the proxy 50 from the plurality of client computing devices 12(1)-12(n) or the network traffic manager apparatus 14. It is to be understood that the proxy 50 may be hardware or software or may represent a system with multiple external resource servers, which may include internal or external networks.

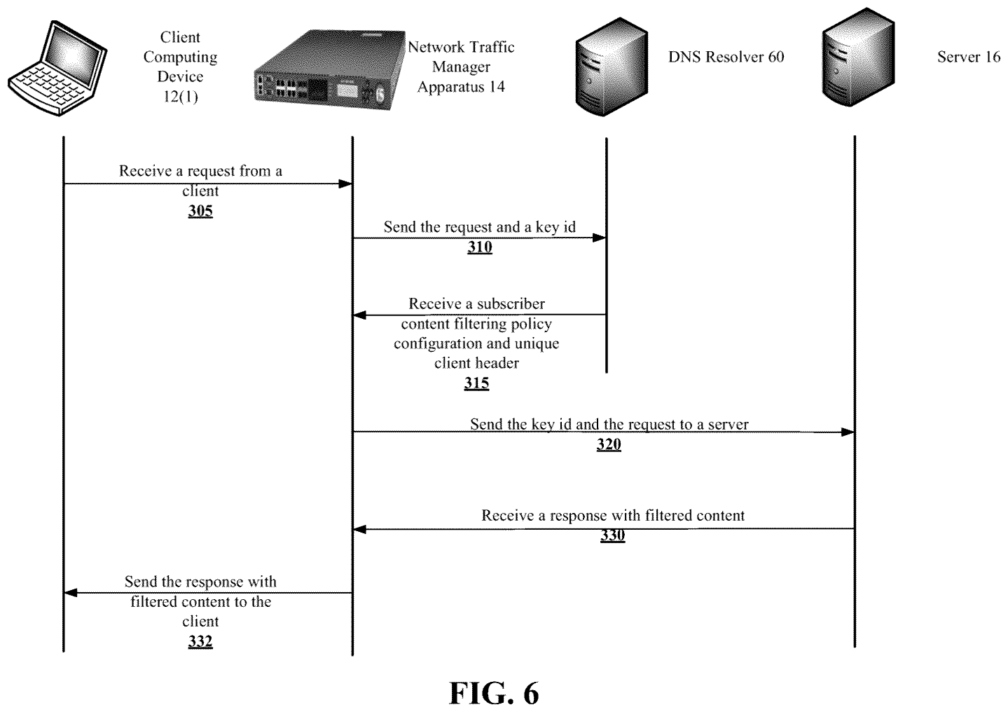

As mentioned above, the plurality of servers 16(1)-16(n) may contain a plurality of servers, such as the proxy server 60, a server 16(1), and an oblivious server 16(2) as illustrated in FIG. 6. The proxy server 60 can also include a central processing unit (CPU) or processor, a memory, and a communication system, which are coupled together by a bus or other link, although other numbers and/or types of network devices could be used. The proxy server 60 may operate as a part of the plurality of network computing devices within cluster architecture of the plurality of servers 16(1)-16(n), a peer-to peer architecture, virtual machines, or within a cloud architecture. In this example, the proxy server 60 operates separately from the architecture of the plurality of servers 16(1)-16(n).

Thus, the technology disclosed herein is not to be construed as being limited to a single environment and other configurations and architectures are also envisaged. For example, the one or more of the plurality of servers 16(1)-16(n) depicted in FIGS. 1 and 2 can operate within network traffic manager apparatus 14 rather than as a stand-alone server communicating with network traffic manager apparatus 14 via the communication network(s) 30. In this example the plurality of servers 16(1)-16(n) operate within the memory of the network traffic manager apparatus 14.

While the network traffic manager apparatus 14 is illustrated in this example as including a single device, the network traffic manager apparatus 14 in other examples can include a plurality of devices or blades each with one or more processors each processor with one or more processing cores that implement one or more steps of this technology. In these examples, one or more of the devices can have a dedicated communication interface or memory. Alternatively, one or more of the devices can utilize the memory, communication interface, or other hardware or software components of one or more other communicably coupled of the devices. Additionally, one or more of the devices that together comprise network traffic manager apparatus 14 in other examples can be standalone devices or integrated with one or more other devices or applications, plurality of servers 16(1)-16(n) or, the network traffic manager apparatus 14, or applications coupled to the communication network(s), for example. Moreover, one or more of the devices of the network traffic manager apparatus 14 in these examples can be in a same or a different communication network 30 including one or more public, private, or cloud networks, for example.

Although an exemplary network traffic management system 10 with the plurality of client computing devices 12(1)-12(n), the network traffic manager apparatus 14, and the plurality of servers 16(1)-16(n), communication networks 30 are described and illustrated herein, other types and numbers of systems, devices, blades, components, and elements in other topologies can be used. It is to be understood that the systems of the examples described herein are for exemplary purposes, as many variations of the specific hardware and software used to implement the examples are possible, as will be appreciated by those skilled in the relevant art(s).

Further, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

One or more of the components depicted in the network traffic management system, such as the network traffic manager apparatus 14, the plurality of client computing devices 12(1)-12(n), the plurality of servers 16(1)-16(n), for example, may be configured to operate as virtual instances on the same physical machine. In other words, one or more of network traffic manager apparatus 14, the plurality of client computing devices 12(1)-12(n), or the plurality of servers 16(1)-16(n) illustrated in FIGS. 1 and 2 may operate on the same physical device rather than as separate devices communicating through a network as depicted in FIG. 1. There may be more or fewer plurality of client computing devices 12(1)-12(n), network traffic manager apparatus 14, or the plurality of servers 16(1)-16(n) than depicted in FIG. 1. The plurality of client computing devices 12(1)-12(n), the plurality of servers 16(1)-16(n) could be implemented as applications on network traffic manager apparatus 14.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

An example of a method for filtering content will now be described with reference to FIGS. 3-6. First in step 305, by way of example, the network traffic manager apparatus 14 receives a domain name system request from one of the plurality of client computing devices 12(1)-12(n), although the network traffic manager apparatus 14 can receive other types or numbers of DNS requests (such as a service binding (“SVCB”) or HTTPS request) and the request can be sent to other systems or devices. For example, the one of the plurality of client computing devices 12(1)-12(n) can send a domain name system request to the proxy 50 or the proxy server 60 as depicted in FIG. 5. A domain name system request can be sent through a proxy 50 to offer privacy to the requesting one of the plurality of client computing devices 12(1)-12(n). Oblivious DNS over HTTPS (“ODOH”) is a standardized technology which offers privacy for browsing. When one of the plurality of client computing devices 12(1)-12(n) sends domain name system request through the proxy 50, the proxy 50 can then send the network traffic manager apparatus 14 the domain name system request without the IP address or identifying the one of the plurality of client computing devices 12(1)-12(n). The proxy 50 can also send the domain name system request without the IP address or identity to a server 16. In this particular example, the network traffic manager apparatus 14 receives the domain name system request from the one of the plurality of client computing devices 12(1)-12(n) as also shown in FIG. 6. In this example, the oblivious server 16(1) is providing an oblivious service where the IP address is removed from requests the oblivious server 16(1) receives.

In step 310, the network traffic manager apparatus 14 sends an address from the domain name system request to a policy server 60. The address can be used by the policy server 60 to retrieve a filter id associated with the client from its memory, although other manners of storing, retrieving or otherwise obtaining the filter id may be used. The proxy server 60 can use one or more methods known in the art to identify and retrieve the filter id associated with the one of the plurality of client computing devices 12(1)-12(n). For example, the proxy server 60 can get an identity of the one of the plurality of client computing devices 12(1)-12(n) from policy charging rules function (“PCRF”) in the internet service provider mobile core or from the packet data network gateway (“PGW”) which can have the identity of the one of the plurality of client computing devices 12(1)-12(n) in the DNS message before it reaches the proxy server 60. The Proxy server can also match the IP address of the one of the plurality of client computing devices 12(1)-12(n) by querying additional servers 16(1)-16(n) or by checking the cache of the proxy server 60. Further, in other examples the proxy server 60 can extract a content filtering id from the header in the domain name system request. In this example, after the policy server 60 retrieves the filter id associated with the client, the network traffic manager apparatus 14 receives the domain name system request with the filter id from the proxy server 60 as illustrated in step 312 in FIG. 6.

In step 315, the network traffic manager apparatus 14 sends the domain name system request with the filter id to an oblivious server 16(2) as further illustrated in FIG. 6. In some examples, sending the domain name system request with the filter id to the oblivious server 16(2) can include sending a generated unique client header comprising the filter id when the domain name system request is sent using hypertext transfer protocol secure to the oblivious server. In this example, the unique client header can be a HTTP header, such as “X-ODOH-Client-Group-ID.” An HTTP header is a field in domain name system request that can pass along additional content and metadata about the domain name system request. In this example, the unique client header can comprise the filter id which can later be used to identity the one of the plurality of client computing devices 12(1)-12(n) sending the domain name system request, although other identification approaches can be used. In this example, including the filter id in the unique client header allows for the domain name system request to continue to have the privacy that the proxy 50 offers by eliminating the IP address from the domain name system request while allowing the header to have the filter id to be used to later obtain the necessary subscriber content filtering policy configuration of the plurality of client computing devices 12(1)-12(n). Other formats known in the art can be used for the HTTP header apart from “X-ODOH-Client-Group-ID.” In some examples, the filter id can be a part of a query name in the domain name system request when the request is sent to the oblivious server 16(2) using transport layer security. Transport Layer Security (“TLS”) is a widely adopted security protocol designed to facilitate privacy and data security for communications over the Internet. A primary use case of TLS is encrypting the communication between web applications and servers, such as web browsers loading a website. Sending the filter id as part of the query name can also be completed when transmission control protocol or user datagram protocol is used. The filter id can also be sent as part of the query name when other similar protocols known in the art is used.

In step 320, the network traffic manager apparatus 14 receives a response with filtered content based on the domain name system request with the filter id from the oblivious server 16(2). The oblivious server 16(2) can generate a subscriber content filtering policy configuration based on the filter id. The oblivious server 16(2) can also generate the response with the filtered content based on the subscriber content filtering policy configuration by using the filtering rules of the subscriber content filtering policy configuration. In this particular example, the subscriber content filtering policy configuration is configured to permit the content in a response to the domain name system request to be filtered, for example based on one or more stored executable rules. Additionally, options like Ethernet interface service (“ENSO”), which is a configurable content filtering parameter that can trigger a filtering service, can be also applied. The subscriber content filtering policy configuration can be configured to block malicious websites and filter out harmful or inappropriate content. As a result, the subscriber content filtering policy configuration can prevent malicious attacks and can also help with the execution of parental or other controls, such as controls based on a setting, e.g. work, school, etc. In this example, the oblivious server 16(2) can maintain a mapping of the subscriber content filtering policy configuration and the filter id in memory. The oblivious server 16(2) can also generate a key id and correlate the key id to the subscriber content filtering policy configuration. The key id can be stored locally and be accessed by the oblivious server 16(2). The plurality of client computing devices 12(1)-12(n) can also generate the same key id using the same logic as the oblivious server 16(2), which is a part of ODOH standards. The key id can also be used for encryption and decryption for future requests as illustrated in FIG. 4, which is why the key id is generated and stored by the oblivious server 16(2) and the plurality of client computing devices 12(1)-12(n).

In step 325, the network traffic manager apparatus 14 sends the one of the plurality of client computing devices 12(1)-12(n) the response to the domain name system request with filtered content and the exemplary process ends at step 330. In this example, the network traffic manager apparatus 14 can also maintain the filter id and the subscriber content filtering policy configuration mapping in memory and cache the response for future subsequent requests from the client. If a new request from the client is received, the network traffic manager apparatus 14 can take the filter id from the request to retrieve the cached response from memory. The cached response can then be sent to the client in response to the new request. It is understood that other methods can be used to identify the response in memory other than using the filtered id.

An example of a method for filtering content will now be described with reference to FIGS. 3-8. When a request is received from a proxy 50 as described above, the source address of the request will be removed from the request if the request is an oblivious domain name system request. An issue can arise when a DNS request is received from a proxy 50 without an IP address of the one of the plurality of client computing devices 12(1)-12(n). Without the IP address or identity of the plurality of client computing devices 12(1)-12(n), the filter id or the subscriber content filtering policy configuration of the plurality of client computing devices 12(1)-12(n) cannot be retrieved. In this example method, after the steps in FIG. 3 have been executed, the oblivious server 16(2) will have the filter id, and subscriber content filtering policy configuration stored in memory. This example explains how a subsequent request from a proxy 50 is handled by the oblivious server 16(2) after the execution of the above steps. First in step 405, the network traffic manager apparatus 14 or the oblivious server 16(2) receives a subsequent oblivious domain name request from the proxy 50. The subsequent oblivious domain name request is encrypted with the key id and comprises of a changed address. The address is changed to give privacy to the source of the subsequent oblivious domain name request. The subsequent oblivious domain name request is also encrypted so that servers or proxies will require the key id to decrypt the subsequent oblivious domain name request. The proxy 50 sends the subsequent oblivious domain name request to the oblivious server 16(2) also to prevent the oblivious server 16(2) from recognizing the source of the subsequent oblivious domain name request. The proxy 50 and plurality of client computing devices 12(1)-12(n) each generate the key id using the same logic which is a part of ODOH standards. This allows for the oblivious server 16(2) to later be able to decrypt the encrypted request as described below.

By way of example, the oblivious server 16(2) can receive a DNS or domain name system subsequent oblivious domain name request from one of the plurality of client computing devices 12(1)-12(n). The oblivious server 16(2) can also receive the subsequent request from the proxy 50 which would have received the subsequent oblivious domain name request from one of the plurality of client computing devices 12(1)-12(n) proxy server 60 as depicted in FIG. 5. A subsequent requests is sent through a proxy 50 to offer privacy to the one of the plurality of client computing devices 12(1)-12(n. The subsequent request in this example is generated by one of the plurality of client computing devices 12(1)-12(n. The proxy 50 removes the IP address and identifying information from the domain name system request, so that a server 16 cannot identify the one of the plurality of client computing devices 12(1)-12(n). When the subsequent request is sent from the one of the plurality of client computing devices 12(1)-12(n) to the proxy 50, the domain name system request or query is encrypted with the key id previously sent to the one of the plurality of client computing devices 12(1)-12(n) in step 330 above.

In step 410, the network traffic manager apparatus 14 or the oblivious server 16(2) retrieves the subscriber content filtering policy configuration from the memory based on the key id. The key id is generated using ODOH standards, so the network traffic manager apparatus 14 or the oblivious server 16(2) have the logic to generate the key id prior to retrieving the subscriber content filtering policy configuration. Because the subscriber content filtering policy configuration corresponding to the one of the plurality of client computing devices 12(1)-12(n) is associated in memory to the key id, the subscriber content filtering policy configuration is able to be located in the cache and retrieved. Then in step 415, the network traffic manager apparatus 14 or the oblivious server 16(2) decrypts the subsequent oblivious domain name system request using the generated key id.

In step 420, the network traffic manager apparatus 14 generates a subsequent oblivious response with filtered content. The subsequent oblivious response is filtered using the filter id and filtering rules from the subscriber content filtering policy configuration. In this example, the server 16 can process the subsequent oblivious domain name system request and generate a subsequent oblivious response using the filtering rules of the subscriber content filtering policy configuration to filter the content in the subsequent response.

In step 425, the network traffic manager apparatus 14 or the oblivious server 16(2) sends the proxy 50 the subsequent oblivious response and the exemplary process ends at step 430. The proxy 50 can then send the subsequent oblivious response to the one of the plurality of client computing devices 12(1)-12(n). The content filtering is completed for the subsequent oblivious domain name system request when the subsequent oblivious response is sent to the proxy 50 or to the one of the plurality of client computing devices 12(1)-12(n) with content filtered.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the technology is limited only by the following claims and equivalents thereto.

What is claimed is:

1. A method for filtering content, the method implemented by one or more network traffic management apparatuses, server devices, or client devices, the method comprising:
receiving a domain name system request from a client;
sending an address from the domain name system request to a policy server, wherein the policy server retrieves a filter id associated with the client;
sending the domain name system request with the filter id to an oblivious server, wherein the domain name system request with the filter id is received from the policy server;
receiving a response with filtered content based on the domain name system request with the filter id from the oblivious server, wherein the oblivious server generates a subscriber content filtering policy configuration based on the filter id and generates the response with the filtered content based on the subscriber content filtering policy configuration; and
sending the response to the domain name system request with filtered content to the client.

2. The method as set forth in claim 1, wherein the oblivious server:
generates and caches a key id, wherein the oblivious server associates the key id with the subscriber content filtering policy in memory; and
caches a mapping between the subscriber content filtering policy configuration and the filter id in memory.

3. The method as set forth in claim 2, wherein the oblivious server:
receives a subsequent oblivious domain name system request from a proxy, wherein the subsequent oblivious domain name system request is encrypted with the key id and comprises a changed address, and wherein the subsequent oblivious domain name system request is sent to the proxy from the client prior to receiving the subsequent oblivious domain name system request from the proxy;
retrieves the subscriber content filtering policy configuration from memory based on the key id;
decrypts the subsequent oblivious domain name system request using the key id;
generates a subsequent oblivious response with filtered content, wherein the subsequent oblivious response is filtered using the filter id and filtering rules from the subscriber content filtering policy configuration; and
sends the proxy the subsequent oblivious response, wherein the proxy sends the subsequent oblivious response to the client after receiving the subsequent oblivious response from the oblivious server.

4. The method as set forth in claim 1, wherein sending the domain name system request with the filter id to the oblivious server further comprises:
sending a generated unique client header comprising the filter id when the domain name system request is sent using hypertext transfer protocol secure to the oblivious server; or
sending the domain name system request with a query name comprising the filter id when the domain name system request is sent with transport layer security to the oblivious server.

5. The method as set forth in claim 1, further comprising:
caching the response with filtered content and a mapping between the filter id and the subscriber content filtering policy configuration;
receiving a subsequent request with the filter id from the client; and
sending the response with filtered content to the client, wherein the response is retrieved from memory based on the filter id.

6. A non-transitory computer readable medium having stored thereon instructions for filtering content comprising executable code which when executed by processors, causes the processors to:
receive a domain name system request from a client;
send an address from the domain name system request to a policy server, wherein the policy server retrieves a filter id associated with the client;
send the domain name system request with the filter id to an oblivious server, wherein the domain name system request with the filter id is received from the policy server;
receive a response with filtered content based on the domain name system request with the filter id from the oblivious server, wherein the oblivious server generates a subscriber content filtering policy configuration based on the filter id and generates the response with the filtered content based on the subscriber content filtering policy configuration; and
send the response to the domain name system request with filtered content to the client.

7. The medium as set forth in claim 6, wherein the oblivious server:
generates and caches a key id, wherein the oblivious server associates the key id with the subscriber content filtering policy in memory; and
caches a mapping between the subscriber content filtering policy configuration and the filter id in memory.

8. The medium as set forth in claim 7, wherein the oblivious server:
receives a subsequent oblivious domain name system request from a proxy, wherein the subsequent oblivious domain name system request is encrypted with the key id and comprises a changed address, and wherein the subsequent oblivious domain name system request is sent to the proxy from the client prior to receiving the subsequent oblivious domain name system request from the proxy;
retrieves the subscriber content filtering policy configuration from memory based on the key id;
decrypts the subsequent oblivious domain name system request using the key id;
generates a subsequent oblivious response with filtered content, wherein the subsequent oblivious response is filtered using the filter id and filtering rules from the subscriber content filtering policy configuration; and
sends the proxy the subsequent oblivious response, wherein the proxy sends the subsequent oblivious response to the client after receiving the subsequent oblivious response from the oblivious server.

9. The medium as set forth in claim 6, wherein the one or more processors are further configured to be capable of executing the programmed instructions stored in the memory to:
send a generated unique client header comprising the filter id when the domain name system request is sent using hypertext transfer protocol secure to the oblivious server; or
send the domain name system request with a query name comprising the filter id when the domain name system request is sent with transport layer security to the oblivious server.

10. The medium as set forth in claim 6, wherein the one or more processors are further configured to be capable of executing the programmed instructions stored in the memory to:
cache the response with filtered content and a mapping between the filter id and the subscriber content filtering policy configuration;
receive a subsequent request with the filter id from the client; and
send the response with filtered content to the client, wherein the response is retrieved from memory based on the filter id.

11. A network traffic manager apparatus, comprising memory comprising programmed instructions stored in the memory and processors configured to be capable of executing the programmed instructions stored in the memory to:
receive a domain name system request from a client;
send an address from the domain name system request to a policy server, wherein the policy server retrieves a filter id associated with the client;
send the domain name system request with the filter id to an oblivious server, wherein the domain name system request with the filter id is received from the policy server;
receive a response with filtered content based on the domain name system request with the filter id from the oblivious server, wherein the oblivious server generates a subscriber content filtering policy configuration based on the filter id and generates the response with the filtered content based on the subscriber content filtering policy configuration; and
send the response to the domain name system request with filtered content to the client.

12. The device as set forth in claim 11, wherein the oblivious server:
generates and caches a key id, wherein the oblivious server associates the key id with the subscriber content filtering policy in memory; and
caches a mapping between the subscriber content filtering policy configuration and the filter id in memory.

13. The device as set forth in claim 12, wherein the oblivious server:
receives a subsequent oblivious domain name system request from a proxy, wherein the subsequent oblivious domain name system request is encrypted with the key id and comprises a changed address, and wherein the subsequent oblivious domain name system request is sent to the proxy from the client prior to receiving the subsequent oblivious domain name system request from the proxy;
retrieves the subscriber content filtering policy configuration from memory based on the key id;
decrypts the subsequent oblivious domain name system request using the key id;
generates a subsequent oblivious response with filtered content, wherein the subsequent oblivious response is filtered using the filter id and filtering rules from the subscriber content filtering policy configuration; and
sends the proxy the subsequent oblivious response, wherein the proxy sends the subsequent oblivious response to the client after receiving the subsequent oblivious response from the oblivious server.

14. The device as set forth in claim 11, wherein the one or more processors are further configured to be capable of executing the programmed instructions stored in the memory to:
send a generated unique client header comprising the filter id when the domain name system request is sent using hypertext transfer protocol secure to the oblivious server; or
send the domain name system request with a query name comprising the filter id when the domain name system request is sent with transport layer security to the oblivious server.

15. The device as set forth in claim 11, wherein the one or more processors are further configured to be capable of executing the programmed instructions stored in the memory to:
cache the response with filtered content and a mapping between the filter id and the subscriber content filtering policy configuration;
receive a subsequent request with the filter id from the client; and
send the response with filtered content to the client, wherein the response is retrieved from memory based on the filter id.

16. A network traffic management system, comprising traffic management apparatuses, server devices, or client devices, the network traffic management system comprising memory comprising programmed instructions stored thereon and processors configured to be capable of executing the stored programmed instructions to:
receive a domain name system request from a client;
send an address from the domain name system request to a policy server, wherein the policy server retrieves a filter id associated with the client;
send the domain name system request with the filter id to an oblivious server, wherein the domain name system request with the filter id is received from the policy server;
receive a response with filtered content based on the domain name system request with the filter id from the oblivious server, wherein the oblivious server generates a subscriber content filtering policy configuration based on the filter id and generates the response with the filtered content based on the subscriber content filtering policy configuration; and
send the response to the domain name system request with filtered content to the client.

17. The network traffic management system as set forth in claim 16, wherein the oblivious server:
generates and caches a key id, wherein the oblivious server associates the key id with the subscriber content filtering policy in memory; and
caches a mapping between the subscriber content filtering policy configuration and the filter id in memory.

18. The network traffic management system as set forth in claim 17, wherein the oblivious server:
receives a subsequent oblivious domain name system request from a proxy, wherein the subsequent oblivious domain name system request is encrypted with the key id and comprises a changed address, and wherein the subsequent oblivious domain name system request is sent to the proxy from the client prior to receiving the subsequent oblivious domain name system request from the proxy;
retrieves the subscriber content filtering policy configuration from memory based on the key id;
decrypts the subsequent oblivious domain name system request using the key id;
generates a subsequent oblivious response with filtered content, wherein the subsequent oblivious response is filtered using the filter id and filtering rules from the subscriber content filtering policy configuration; and
sends the proxy the subsequent oblivious response, wherein the proxy sends the subsequent oblivious response to the client after receiving the subsequent oblivious response from the oblivious server.

19. The network traffic management system as set forth in claim 16, wherein the one or more processors are further configured to be capable of executing the programmed instructions stored in the memory to:
send a generated unique client header comprising the filter id when the domain name system request is sent using hypertext transfer protocol secure to the oblivious server; or
send the domain name system request with a query name comprising the filter id when the domain name system request is sent with transport layer security to the oblivious server.

20. The network traffic management system as set forth in claim 16, wherein the one or more processors are further configured to be capable of executing the programmed instructions stored in the memory to:
cache the response with filtered content and a mapping between the filter id and the subscriber content filtering policy configuration;
receive a subsequent request with the filter id from the client; and
send the response with filtered content to the client, wherein the response is retrieved from memory based on the filter id.
